(19) United States
(12) Patent Application Publication
(10) Pub. No.: US 2024/0059117 A1
(43) Pub. Date: Feb. 22, 2024

(54) METHOD FOR CORRECTING A HEIGHT VALUE, MEASURED USING A HEIGHT SENSOR, OF A MOTOR VEHICLE BY A CORRECTION VALUE

(71) Applicant: Continental Automotive Technologies GmbH, Hannover (DE)

(72) Inventors: Frank Wolters, Süpplingenburg (DE); Klaus Wenger, Apelern (DE); Hermann Hoinkhaus, Burgwedel (DE)

(73) Assignee: Continental Automotive Technologies GmbH, Hannover (DE)

(21) Appl. No.: 18/235,069

(22) Filed: Aug. 17, 2023

(30) Foreign Application Priority Data
Aug. 19, 2022 (DE) 10 2022 208 608.2

(51) Int. Cl. B60G 17/016

(52) U.S. Cl. CPC B60G 17/0164; B60G 2400/252; B60G 2500/30; B60G 2400/104; B60G 2400/106; B60G 2600/1877

(57) ABSTRACT

Method for correcting a height value, measured using a height sensor, of a spring-damper unit of a motor vehicle, wherein the measured height value is corrected by a correction value that is dependent on an acceleration value if the motor vehicle is accelerated in a longitudinal and/or lateral direction, the correction value being adjusted while the motor vehicle is moving.

### CROSS-REFERENCE TO RELATED APPLICATIONS

This application claims priority to German patent application No. DE 10 2022 208 608.2, filed Aug. 19, 2022, which is hereby incorporated by reference.

### TECHNICAL FIELD

The technical field relates to correcting a height value, measured using a height sensor, of a motor vehicle.

### BACKGROUND

A height value measured using a height sensor may be corrected by a correction value that is dependent on vehicle parameters to prevent unnecessary ride height compensation when the ride height position of a motor vehicle changes. This is because a motor vehicle equipped with an actively adjustable chassis continually undergoes a target/actual comparison for the vehicle height, or ride height position. In the event of a difference, the ride height position is adjusted, that is to say a ride height control process is carried out.

Some methods for ride height control of a motor vehicle are known. The ride height position of the motor vehicle is adjusted in a situation-dependent manner as a result of detection of the motor vehicle height in relation to the chassis with an appropriate sensor system. In this regard, for example, loading of the motor vehicle can be followed by ride height compensation being carried out, or the motor vehicle is lowered while travelling in order to save fuel.

Such ride height control can be implemented, for example, by an air suspension system as a component part of an actively adjustable chassis. The main components of the air suspension system are air springs filled with compressed air, which cushion the vehicle body, and an air supply device, which provides the compressed air. These two components are connected to one another via pneumatic lines. There are also various sensors, such as height and pressure sensors, and a control unit, which is functional as a control and evaluation device. Electromagnetic switching valves, which are actuated by the control unit to control the throughflow of the compressed air, are provided in the pneumatic lines. Of course, the sensors and the switching valves are connected to the control unit via electrical lines.

The air suspension system therefore allows the height/ride height of the vehicle body to be actively changed in relation to the chassis by opening and closing certain switching valves. According to requirements, the air springs are filled with or emptied of compressed air in order to adjust the vehicle ride height. Height means the distance of the vehicle body (bodywork) from the vehicle axles. Since the respective distance of the vehicle body from the chassis axles can vary, the term ride height is also used.

A chassis sensor is generally used in order to determine the current ride height position of the motor vehicle, said chassis sensor detecting the spring travel of the wheel as an unsprung mass in relation to the vehicle body as a sprung mass. Such a chassis sensor is fitted in the region of the wheel suspension or the spring-damper unit of the motor vehicle in order to determine the spring travel of the wheel in relation to the vehicle body. Such chassis sensors are also referred to as height sensors, vertical sensors, ride height sensors or spring travel sensors. The spring travel sensor transmits its signal to an electronic open-loop and closed-loop control device of the motor vehicle, the signal being processed further in said open-loop and closed-loop control device.

Brief driving dynamics influences, such as longitudinal or lateral acceleration, can lead to a pitching and rolling moment for the vehicle. This influences the vertical forces acting on the spring-damper units and leads to a change of height. The measured actual height value of the spring-damper units then differs from the target height value, with the result that ride height compensation is carried out. That is to say that such brief driving dynamics influences can cause unwanted ride height compensation. If the driving dynamics influence disappears, the vertical forces also change and the ride height adjustment previously carried out leads to another difference from the target ride height position, or to the vehicle body being imbalanced. Accordingly, a further ride height control process needs to be carried out in order to reset the vehicle body to the target ride height. Two control processes are thus performed in total, which are not desirable and also adversely affect vehicle safety and comfort.

In order to prevent such unnecessary control processes and an imbalance in the motor vehicle, the prior art involves a brief acceleration process resulting in the measured actual height value being corrected. The measured values measured by the height sensors are thus adjusted in an appropriate manner during the acceleration process of the motor vehicle so that the target/actual comparison that is constantly taking place causes no ride height adjustment during the acceleration process. An open-loop and closed-loop control device of the motor vehicle stores height correction values linked to the longitudinal or lateral acceleration. These correction values are implemented for each spring-damper unit, or wheel, and type of acceleration (longitudinal or lateral) as a characteristic curve.

As such, for example the document DE 102 25 940 A1 discloses the practice of using correction values for the measurement signals (actual height value) that are dependent on the vehicle speed or vehicle acceleration. A separate table for the two vehicle parameters is stored in an open-loop and closed-loop control device of the motor vehicle, said table linking individual values of the respective parameter to a specific correction value. If the actual height values of the individual spring-damper units are set against the acceleration-dependent correction values, the result is no control requirement. These correction values are vehicle-specific and need to be ascertained empirically for each vehicle, and are then stored permanently in the electronic open-loop and closed-loop control device.

As this method does not take sufficient account of further driving-dynamics influences or the interaction thereof, however, the document DE 10 2007 048 903 A1 proposes taking account of at least two vehicle parameters when reading off the correction value. A family of characteristics that is stored in the control unit of the motor vehicle and keeps correction values for the interacting longitudinal and lateral acceleration is used in this case. For each interacting longitudinal and lateral acceleration, the control unit takes a correction value dependent thereon from the family of characteristic curves and corrects the actual value. Here too, the relationship between the correction value and the vehicle parameter is predetermined and permanently stored in the control unit.

It can thus be seen that the necessary height correction values for longitudinal and lateral acceleration need to be ascertained empirically during vehicle setup. This requires various driving maneuvers to be carried out with a vehicle, for example, in order to generate specific acceleration values. During the subsequent consideration and analysis of the measurement data, the height change is determined for each spring-damper unit on the basis of the predefined acceleration values and converted into a height value correction characteristic curve. If a motor vehicle has multiple target ride height positions, a corresponding number of driving experiments need to be performed in order to be able to distinguish the height changes caused by acceleration within the various target ride height positions from one another. This leads to considerable added complexity for the empirical definition of the correction values. Vehicle series are also divided into multiple variants. Correct determination of the correction values thus requires setup for each individual variant of a series. In addition, the vehicle mass can differ within a variant or different target ride height positions are set within the variant, with the result that the vehicle body behaves differently during an acceleration. Manufacturing tolerances within a variant can also lead to different behavior during an acceleration. This problem is additionally aggravated by the aging of chassis components, with the result that behavior during an acceleration also changes over the life of the motor vehicle. It is not feasible for all of these constraints to be taken into consideration when setting up the correction values.

As such, it is desirable to present a method for correcting a height value, measured using a height sensor, of a motor vehicle so that the correction value for the respective motor vehicle is set as accurately as possible. In addition, other desirable features and characteristics will become apparent from the subsequent summary and detailed description, and the appended claims, taken in conjunction with the accompanying drawings and this background.

### SUMMARY

In one exemplary embodiment, the disclosure provides a method for correcting a height value, measured using a height sensor, of a spring-damper unit of a motor vehicle. The measured height value is corrected by a correction value that is dependent on an acceleration value if the motor vehicle is accelerated in a longitudinal and/or lateral direction. The correction value is adjusted while the motor vehicle is moving.

The advantage of this method is that the acceleration-dependent height correction values are ascertained in an automated manner and individually for the motor vehicle. The acceleration-dependent height correction values are also adjusted over the entire life of the motor vehicle. This reduces unwanted ride height control processes during a longitudinal and/or lateral acceleration and increases the control accuracy for wanted control processes under the influence of a longitudinal and/or lateral acceleration. As a result, system wear and energy consumption are reduced, and general driving safety is increased.

The correction value may be adjusted on the basis of a height change of the spring-damper unit, the height change being caused by a longitudinal or lateral acceleration of the motor vehicle. If the motor vehicle undergoes only a longitudinal acceleration, for example, then this can be used to measure the height change occurring at the spring-damper units that is caused by the longitudinal acceleration, and this height change can be used to adjust the correction values. The height change of the spring-damper units that has occurred during constant vehicle operation under certain conditions can be used to adjust the correction values to the individual circumstances that change over the life of the motor vehicle.

The height change of the spring-damper unit may be ascertained from a reference height value and an acceleration-dependent height value. In order to ascertain the height change at a spring-damper unit, a reference height value is stipulated and an acceleration-dependent height value is read off. The reference height value represents the zero position of the spring-damper unit when the latter is at rest and is not vertically deflected. The acceleration-dependent height value is dependent on the acceleration that has occurred in the motor vehicle, and is read off on the basis of specific acceleration values.

As such, the acceleration-dependent height value may be read off on the basis of a predetermined acceleration interpolation point value. The acceleration interpolation point value is a predetermined acceleration value for which the height of the spring-damper unit is read off. If for example the motor vehicle is accelerated to 5 m/s2 in the longitudinal direction, the height value of the spring-damper unit is read off for this acceleration and stored as an acceleration-dependent height value.

The reference height value may be stipulated when at least the following conditions exist:
a vehicle speed of the motor vehicle is above a predetermined speed threshold value, and
the longitudinal and lateral acceleration of the motor vehicle are below a respective predetermined acceleration threshold value, and
a steering angle of the motor vehicle is below a predetermined steering angle threshold value, and
a gradient of the height value measured using the height sensor is below a predetermined gradient threshold value or the height value measured using the height sensor is within a height value threshold value range, and
if these conditions are met, no ride height control process for the motor vehicle must have taken place within a predetermined period of time beforehand.

In order to determine a reliable zero position of the spring-damper unit around which the latter compresses and expands, the motor vehicle needs to be in a static driving state. In particular, it must be subject to no dynamic influences that cause the spring-damper units to move vertically. That is to say that if the cited conditions exist, a driving state in which the reference height value can be stipulated is assumed.

According to one illustrative embodiment, the ascertained height change of the spring-damper unit is supplied iteratively to an averaging section, resulting in an average height change value that is used to adjust the correction value.

Alternatively, in one illustrative embodiment, the ascertained height change of the spring-damper unit is supplied iteratively to a weighted averaging section, in which the ascertained height change is multiplied by a weighting factor, resulting in a weighted-average height change value that is used to adjust the correction value.

The average or weighted-average height change value may represent the adjusted correction value.

According to one illustrative embodiment, the adjusted correction value is stored in an adaptive acceleration value/correction value characteristic curve.

The method may be carried out using an electronic open-loop and closed-loop control device of the motor vehicle. This may be the electronic open-loop and closed-loop control device of the actively adjustable chassis. A chassis may be an air suspension installation having a number of air springs or air spring-dampers and a compressed air supply device.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 shows a motor vehicle on a roadway,

FIG. 2 shows an illustrative acceleration value/height value graph, and

FIG. 3 shows an illustrative acceleration value/correction value graph.

### DETAILED DESCRIPTION

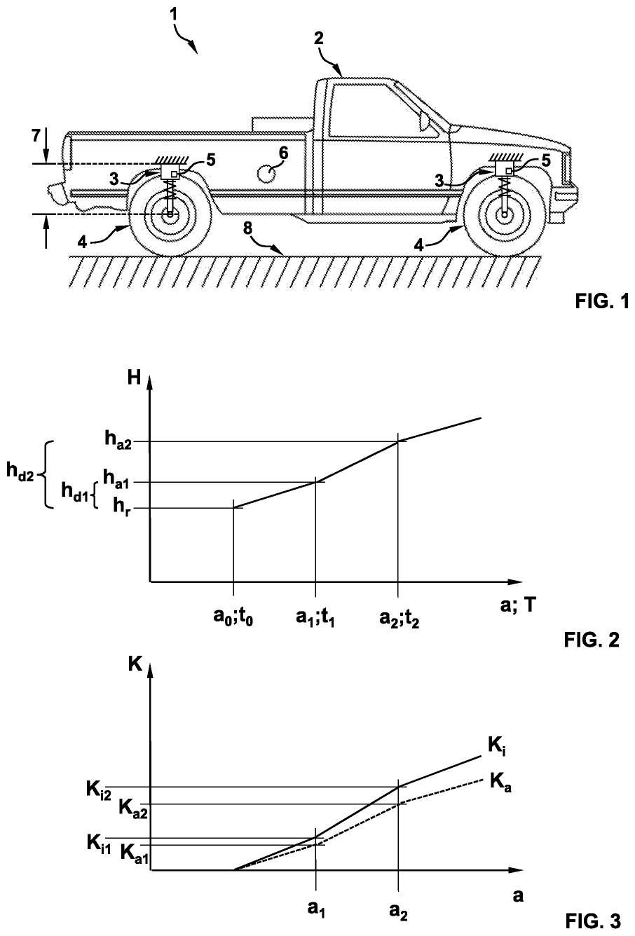

FIG. 1 schematically shows a motor vehicle 1 whose wheels 4 are moving along a roadway 8. The motor vehicle 1 comprises a vehicle body 2, which is spring-mounted as a sprung mass in relation to the respective wheels 4 as unsprung masses by a multiplicity of spring-damper units 3. The spring-damper units 3 of the front and rear axles have respective associated height sensors 5. It goes without saying that two spring-damper units 3 with respective height sensors 5 are provided on each axle of the motor vehicle 1.

Height sensors 5 are used to measure a height 7 of the vehicle body 2 in relation to the wheel 4 as a component part of the vehicle chassis. The height 7 is the distance between the upper attachment of the spring-damper unit 3 to the vehicle body 2 and the lower attachment of the spring-damper unit 3 to the wheel support, or wheel 4. As a result, the height sensor 5 is used to measure the relative distance between the vehicle body 2 as a sprung mass and the wheel 4 as an unsprung mass. The measurement signals from the height sensors 5 are supplied continuously to an electronic open-loop and closed-loop control device 6 of the motor vehicle 1, where they are processed. There, the measurement signals generally undergo filtering in order to be processed further as smoothed height values, or for the purpose of target/actual control of the ride height position of the motor vehicle 1. The measurement signals from the height sensors 5 thus provide information about the current ride height position of the motor vehicle 1.

According to the prior art, the electronic open-loop and closed-loop control device 6 of the motor vehicle 1 stores correction values, or a family of characteristic curves containing correction values, that are dependent on an acceleration of the motor vehicle 1. The acceleration is generally a longitudinal and/or lateral acceleration of the motor vehicle 1. The correction values are linked to specific acceleration values and are read in an appropriate manner as soon as the motor vehicle 1 undergoes an acceleration in the longitudinal and/or lateral direction, with the result that correction of the height values is necessary. If the motor vehicle 1 undergoes a longitudinal acceleration, for example, the front axle is raised. That is to say that the spring-damper units 5 of the front axle are expanded and a height change occurs that is caused by the acceleration. The actual height value measured using the height sensor 5 differs from a target height value, with the result that a ride height control process would actually need to be triggered. However, this is prevented by setting the height value measured using the height sensor 5 against a correction value that is dependent on the acceleration that occurs. This correction value may be incorrect during vehicle operation, however, on account of the facts cited in the introduction. That is to say that if, e.g., the stored correction value differs too greatly from the height change caused by the acceleration, an undesirable ride height control process could be carried out. This means that the acceleration-dependent correction value stored in the system is no longer correct for the acceleration that has occurred. Accordingly, the actual height value is corrected by an incorrect correction value, and during the subsequent target/actual comparison a difference is ascertained that results in ride height compensation that is actually unwanted. Acceleration-dependent correction values that are no longer correct are therefore safety-critical.

FIGS. 2 and 3 that follow are intended to be used to explain the illustrative method for correcting a height value measured using a height sensor in more detail, said method ensuring that the correction value used is selected as precisely as possible.

The graph in FIG. 2 is intended to be used to explain the adaptive selection of a correction value during vehicle operation. The graph shows the acceleration a and time T on the x-axis. The height H is plotted on the y-axis. The solid line is used to illustrate the response of the height value H of a spring-damper unit as acceleration a increases by way of example. To be able to select or adjust a correction value, a height change ha; ha at a spring-damper unit is ascertained that was caused by an acceleration of the motor vehicle, for example in a longitudinal direction.

So that the height change ha; ha can be calculated, there is first a need for a reference height value hr. The reference height hᵣ represents the zero position around which the height of the spring-damper unit changes positively or negatively when the motor vehicle undergoes an acceleration. To be able to determine the reference height hᵣ, the motor vehicle must not be subject to driving dynamics influences. As such, at least the following conditions must exist together in order for the reference height hᵣ to be able to be stipulated: The motor vehicle must be moving; it must not be stationary. The vehicle speed must thus be above a predetermined speed threshold value. The longitudinal and lateral acceleration must also be below respective predetermined acceleration threshold values. In addition, a steering angle must be below a predetermined steering angle threshold value. Furthermore, it is necessary for the height value H of the spring-damper unit not to vary too greatly. As such, the gradient of the height value H measured using the height sensor is meant to be below a predetermined gradient threshold value or the height value H measured using the height sensor must be within a height value threshold value range. If these conditions exist, no ride height control process must have taken place within a certain period of time beforehand in order for the reference height value hᵣ to be able to be stipulated. In the graph, the stipulation is made by way of example at a reference time to, at which the cited conditions are met.

If the motor vehicle is then accelerated in the longitudinal direction, for example, at another time, and a lateral acceleration is then below a predetermined lateral acceleration threshold value, it is possible to ascertain acceleration-dependent height values Hₐ₁; Hₐ₂, from which the height change h_{d1}; h_{d2} is calculated. As such, there is provision for a first acceleration interpolation point value a1 and a second acceleration interpolation point value a₂, for example, on the basis of which the acceleration-dependent height values Hₐ₁; Hₐ₂ are read off. If the motor vehicle undergoes only a longitudinal acceleration at a first time t₁, for example, and said acceleration is at the first acceleration interpolation point value a₁ (for example 1 m/s²), then a first acceleration-dependent height value ha1 is read off that was present at the spring-damper unit at this time, or was caused by this acceleration value. It is therefore possible to use the first acceleration-dependent height value ha1 (for example 6 mm) and the reference height value hᵣ (for example 0) to calculate a first height change h_{d1} (for example 6 mm). This ascertained first height change hd1 is then used to adjust the correction value assigned to the first acceleration interpolation point value a₁. This ascertainment can also be performed for an acceleration of the motor vehicle in the lateral direction if a longitudinal acceleration is below a predetermined longitudinal acceleration threshold value.

If, over the course of time, the motor vehicle undergoes a further longitudinal acceleration to a second acceleration interpolation point value a₂ (for example 2 m/s²) at a second time t₂, said second acceleration interpolation point value can be taken as a basis for reading off a second acceleration-dependent height value hₐ₂. Accordingly, the second acceleration-dependent height value hₐ₂ (for example 14 mm) and the reference height value hᵣ (for example 0) are used to calculate a second height change h_{d2} (for example 14 mm). This second height change h_{d2} is then taken as a basis for adjusting the correction value for the second acceleration interpolation point value az.

This illustrative method is carried out repeatedly if the aforementioned necessary constraints exist. As such, the correction value is preferably not adjusted on the basis of the most recently measured height change h_{d1}; h_{d2}, but rather the ascertained height changes are averaged over the repeating measurement processes. For example, the ascertained height change h_{d1}; h_{d2} of the current calculation is added to the height changes of the previous calculations and divided by the total number of calculations performed. Furthermore, the height change h_{d1}; h_{d2} of the current calculation is preferably weighted by multiplying it by a weighting factor. The weighting factor is dependent on the number of calculations already iteratively performed, with the result that the height change h_{d1}; h_{d2} of the current calculation is included in the averaging to an ever smaller extent. The weighting factor=1/n, n being the total number of iterative calculations of the height change h_{d1}; h_{d2}.

The method is not limited to the adjustment of a correction value from an acceleration-induced height value, but rather a correction value characteristic curve is formed that results from consideration of the acceleration-induced height change. The correction value characteristic curve contains a multiplicity of acceleration interpolation point values linked to respective correction values, the correction values being adaptively defined on the basis of the height change h_{d1}; h_{d2}.

The graph in FIG. 3, then, is thus intended to be used to explain the adaptive selection of a correction value K in more detail. The acceleration a is plotted on the x-axis and the correction K is plotted on the y-axis. The solid line is used to show an initial correction value characteristic curve Kᵢ by way of example and the dashed line is used to show an adaptive correction value characteristic curve Kₐ by way of example.

First, the electronic open-loop and closed-loop control device of the motor vehicle values used for correcting the height values are not established for the life of the motor vehicle, however, but rather are adaptive by way of illustration. That is to say that if it was must initially store an acceleration-dependent correction value characteristic curve Kᵢ. The acceleration-dependent correction possible to determine a height change of the spring-damper unit under the conditions described above, then these values can be used to convert the initial correction value characteristic curve Kᵢ into an adaptive correction value characteristic curve Kₐ. The method for correcting a height value, measured using a height sensor, of a spring-damper unit of a motor vehicle, which corrects the measured height value by a correction value K that is dependent on an acceleration value, then no longer uses the initial correction value characteristic curve Kᵢ, but rather obtains the acceleration-dependent correction values K from the adaptive correction value characteristic curve Kₐ.

That is to say that after the height change has been calculated for the first time, a first initial correction value Kᵢ₁ for the first acceleration interpolation point value a₁ is replaced by a first adaptive correction value Kₐ₁ and a second initial correction value Kᵢ₂ for the second acceleration interpolation point value a₂ is replaced by the second adaptive correction value Kₐ₂. From then on, the constantly adapting correction value characteristic curve Kₐ is used for correcting the height value.

Producing the adaptive correction value characteristic curve Kₐ also has the advantage that changes to the spring-damper units or the chassis over the life of the motor vehicle can be observed and identified. Comparing the initial correction value characteristic curve Kᵢ with the adaptive correction value characteristic curve Kₐ reveals differences caused for example by wear. It is also possible to continually check whether the adaptive correction value characteristic curve Kₐ is within a predefined tolerance, and if this is not the case, a service report can be sent.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method for correcting a height value, measured using a height sensor, of a spring-damper unit of a motor vehicle, wherein the measured height value is corrected by a correction value that is dependent on an acceleration value if the motor vehicle is accelerated in a longitudinal and/or lateral direction, wherein the correction value is adjusted while the motor vehicle is moving.

2. The method as claimed in claim 1, wherein the correction value is adjusted on the basis of a height change of the spring-damper unit, the height change being caused by a longitudinal or lateral acceleration of the motor vehicle.

3. The method as claimed in claim 2, wherein the height change of the spring-damper unit is ascertained from a reference height value and an acceleration-dependent height value.

4. The method as claimed in claim 3, wherein the acceleration-dependent height value is read off on the basis of a predetermined acceleration interpolation point value.

5. The method as claimed in claim 3, wherein the reference height value is stipulated when at least the following conditions exist:
a vehicle speed of the motor vehicle is above a predetermined speed threshold value, and
the longitudinal and lateral acceleration of the motor vehicle are below a respective predetermined acceleration threshold value, and
a steering angle of the motor vehicle is below a predetermined steering angle threshold value, and
a gradient of the height value measured using the height sensor is below a predetermined gradient threshold value or the height value measured using the height sensor is within a height value threshold value range, and
if these conditions are met, no ride height control process for the motor vehicle must have taken place within a predetermined period of time beforehand.

6. The method as claimed in claim 3, wherein the ascertained height change of the spring-damper unit is supplied iteratively to an averaging section, resulting in an average height change value that is used to adjust the correction value.

7. The method as claimed in claim 6, wherein the average height change value represents the adjusted correction value.

8. The method as claimed in claim 3, wherein the ascertained height change of the spring-damper unit is supplied iteratively to a weighted averaging section, in which the ascertained height change is multiplied by a weighting factor, resulting in a weighted-average height change value that is used to adjust the correction value.

9. The method as claimed in claim 8, wherein the weighted-average height change value represents the adjusted correction value.

10. The method as claimed in claim 1, wherein the adjusted correction value is stored in an adaptive acceleration value/correction value characteristic curve.

11. The method as claimed in one of claim 1, wherein the method is carried out using an electronic open-loop and closed-loop control device of the motor vehicle.
